(19) United States
(12) Patent Application Publication
(10) Pub. No.: US 2023/0318833 A1
(43) Pub. Date: Oct. 5, 2023

(54) SYSTEMS AND METHODS FOR MANAGING TOKENS

(71) Applicants: Stuart A. Haber, New York, NY (US); Scott W. Stornetta, Morristown, NJ (US)

(72) Inventors: Stuart A. Haber, New York, NY (US); Scott W. Stornetta, Morristown, NJ (US)

(21) Appl. No.: 18/127,931

(22) Filed: Mar. 29, 2023

Related U.S. Application Data
(60) Provisional application No. 63/324,698, filed on Mar. 29, 2022.

(51) Int. Cl. H04L 9/32; G06Q 40/06

(52) U.S. Cl. CPC H04L 9/3213; H04L 9/3263; G06Q 40/06

(57) ABSTRACT

A system for managing nonfungible tokens, comprising a computing device configured to receive an indication of a first process associating a first token with a first quantitative field, the first token linked to a first verification datum, identify at least a second process in a log, the at least a second process being associated with at least a second token, the at least a second token linked to a second verification datum, identify a first proportion of the quantitative field, the first proportion linked to the first verification datum, calculate at least a second proportion of the quantitative field, and generate at least a third process linking the at least a second proportion to the second verification datum.

### CROSS-REFERENCE TO RELATED APPLICATIONS

This application claims the benefit of priority of U.S. Provisional Patent Application Ser. No. 63/324,698, filed on Mar. 29, 2022, and titled “SYSTEMS AND METHODS FOR MANAGING NONFUNGIBLE TOKENS” which is incorporated by reference herein in its entirety.

### FIELD OF THE INVENTION

The present invention generally relates to the field of tokens. In particular, the present invention is directed to managing tokens.

### BACKGROUND

Nonfungible tokens provide reliable proof of ownership of assets. However, reliable proof of ownership of disparate tokens remains elusive.

### SUMMARY OF THE DISCLOSURE

In an aspect of the present disclosure is a system for managing nonfungible tokens including a computing device configured to receive an indication of a first process associating a first token with a first quantitative field, the first token linked to a first verification datum, identify at least a second process in a log, the at least a second process being associated with at least a second token, the at least a second token linked to a second verification datum, identify a first proportion of the quantitative field, the first proportion linked to the first verification datum, calculate at least a second proportion of the quantitative field, and generate at least a third process linking the at least a second proportion to the second verification datum.

In another aspect of the present disclosure is a method for managing tokens including receiving, at a computing device, an indication of a first process associating a first token with a first quantitative field, the first token including a first verification datum, identifying, by the computing device, at least a second process in a log, the at least a second process being associated with at least a second token, the at least a second token including at least a second verification datum, identifying, by the computing device, a first proportion of the first quantitative field to be transferred to the first verification datum, calculating, by the computing device, at least a second proportion of the first quantitative field to be transferred to the at least a second verification datum, and generating, by the computing device, at least a third process assigning the at least a second proportion of the first quantitative field.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating a system for managing nonfungible tokens according to an embodiment in the present disclosure;

FIG. 2 is a block diagram of an exemplary immutable sequential listing;

FIG. 3 is block diagram of a cryptographic accumulator;

FIG. 4 is a block diagram of an upgradable smart contract;

FIG. 5 is a flow diagram of a method for managing nonfungible tokens according to an embodiment in the present disclosure; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for tokens. In an embodiment, a system includes a first computing device communicatively connected to a network including at least a second computing device. The network may be configured to distribute to the first and second computing devices a log including tokens and a self-executing data structure. The self-executing data structure may be configured to distribute a royalty from a sale of a first of tokens to an owner of a second of tokens. The royalty may be based on established shares of each of tokens. In some embodiments, each token has the same shares. In some embodiments, tokens have differing numbers of shares. Shares may be revised based on the latest purchase prices of tokens and/or the assets of which they represent ownership. This creates an incentive to purchase tokens early and provides a royalty sharing among current owners of the tokens. Exemplary embodiments illustrating aspects of the present disclosure are described below in the context of several specific examples.

A cryptographic system is a system for protecting information, in at least one of two different ways: first, ensuring that certain data items can only be intelligible to their intended recipients; and second, ensuring that certain data items cannot be modified undetectably. A cryptographic system may be configured to convert data from a first form, known as “plaintext,” which is intelligible when viewed in its intended format, into a second form, known as “ciphertext,” which is not intelligible when viewed in the same way. Ciphertext may be unintelligible in any format unless first converted back to plaintext. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is Rivest-Shamir-Adleman (RSA), in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

In some embodiments, systems and methods described herein produce cryptographic hashes, also referred to by the equivalent shorthand term “hashes.” A cryptographic hash, as used herein, is a mathematical representation of a lot of data, such as files or blocks in a block chain as described in further detail below; the mathematical representation is produced by a lossy “one-way” algorithm known as a “hashing algorithm.” Hashing algorithm may be a repeatable process; that is, identical lots of data may produce identical hashes each time they are subjected to a particular hashing algorithm. Because hashing algorithm is lossy, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

In an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Poly1305-AES, Elliptic Curve Only Hash (“ECOH”) and similar hash functions, Fast-Syndrome-based (FSB) hash functions, GOST hash functions, the Grostl hash function, the HAS-160 hash function, the JH hash function, the RadioGatún hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2^{n/2}) for n output bits; thus, it may take on the order of 2²⁵⁶ operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

Embodiments disclosed herein may be configured to generate, analyze, verify, or otherwise utilize secure proofs. A “secure proof,” as used in this disclosure, is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

Secure proof may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from a public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. in a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

Alternatively, zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup; as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

Zero-knowledge proof may include any other suitable zero-knowledge proof. Zero-knowledge proof may include, without limitation, bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (IOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

In an embodiment, secure proof may be implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation. A single key may be used in one or more digital signatures as described in further detail below, such as signatures used to receive and/or transfer possession of crypto-currency assets; the key may be discarded for future use after a set period of time. In an embodiment, varied inputs include variations in local physical parameters, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system, or using a private key of a symmetric cryptographic system; for instance, trusted party may verify response by decrypting an encryption of challenge or of another datum using either a symmetric or public-key cryptographic system, verifying that a stored key matches the key used for encryption as a function of at least a device-specific secret. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

Embodiments described in this disclosure may perform, verify, analyze, generate, or otherwise utilize digital signatures. A “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described above, including without limitation encryption using a private key of a public key cryptographic system as described above. Signature may be verified using a verification datum suitable for verification of a secure proof; for instance, where secure proof is enacted by encrypting message using a private key of a public key cryptographic system, verification may include decrypting the encrypted message using the corresponding public key and comparing the decrypted representation to a purported match that was not encrypted; if the signature protocol is well-designed and implemented correctly, this means the ability to create the digital signature is equivalent to possession of the private decryption key and/or device-specific secret. Likewise, if a message making up a mathematical representation of file is well-designed and implemented correctly, any alteration of the file may result in a mismatch with the digital signature; the mathematical representation may be produced using an alteration-sensitive, reliably reproducible algorithm, such as a hashing algorithm as described above. A mathematical representation to which the signature may be compared may be included with signature, for verification purposes; in other embodiments, the algorithm used to produce the mathematical representation may be publicly available, permitting the easy reproduction of the mathematical representation corresponding to any file.

In some embodiments, digital signatures may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. The digital certificate may include a digital signature.

In some embodiments, a third party such as a certificate authority (CA) is available to verify that the possessor of the private key is a particular entity; thus, if the certificate authority may be trusted, and the private key has not been stolen, the ability of an entity to produce a digital signature confirms the identity of the entity and links the file to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature.

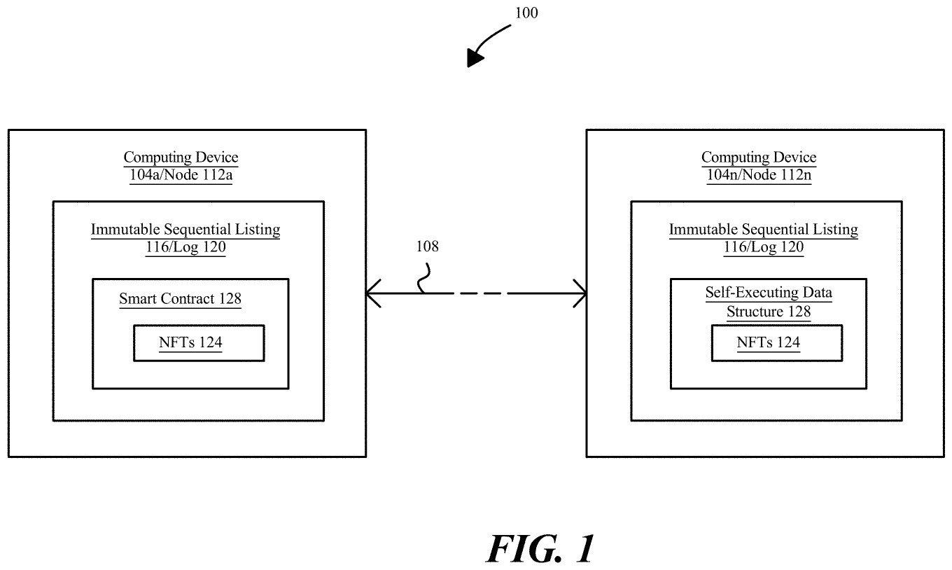

Now referring to FIG. 1, a system for managing tokens is illustrated. System 100 may include a computing device 104. Computing device 104 may include without limitation, a server, a desktop computer, a handheld device or mobile device such as a smartphone or tablet, and/or a special purpose device. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network 108 include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. Network 108 may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for distribution of tasks or memory between computing devices. Computing device 104 may be implemented using a “shared nothing” architecture in which data is cached at the worker, in an embodiment, this may enable scalability of system 100 and/or computing device.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, computing device 104 may include a plurality of computing devices 104a-n. System 100 may include two or more computing devices 104a-n working in concert or in parallel may include, for instance, a first server or cluster of servers in a first location and a second server or cluster of servers in a second location. System 100 may include one or more computing devices 104a-n dedicated to data storage, security, distribution of traffic for load balancing, and the like. System 100 may distribute one or more computing tasks as described below across a plurality of computing devices of system 100, which may operate in parallel, in series, redundantly, or in any other manner used for distribution of tasks or memory between computing devices. System 100 may be implemented using a “shared nothing” architecture in which data is cached at the worker; in an embodiment, this may enable scalability of system 100 and/or system 100. System 100 may be configured to determine access rights of a requestor; a requestor as used herein is a user who may be requesting access to stored data or to access one or more encrypted data records as described in further detail below, where access to data may include having the data provided to the requestor, or having the data provided by the requestor to another party as described in further detail below. System 100 may be configured to perform validation of data according to methods and/or systems as described in further detail below. In some embodiments, computing devices 104a-n may communicate over network 108 locally or remotely to each other to perform one or more embodiments of processes and/or process steps as disclosed in further detail below. Computing device 104 may include and/or implement one or more network accessible knowledge bases containing information of one or more users that may include other secure processors connected to network 108. Computing devices 104a-n may include nodes 112a-n of system 100. Computing device 104 may include, without limitation, at least a user device, at least a third-party validator device, and/or a service or component thereof.

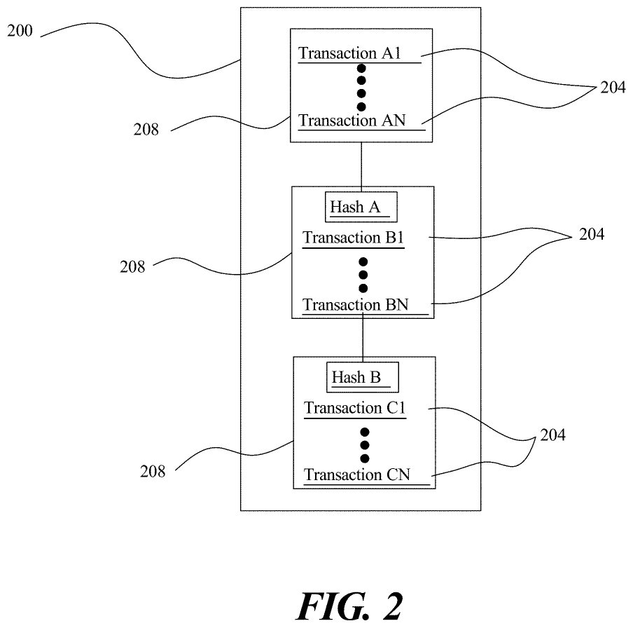

With continued reference to FIG. 1, system 100 may include an immutable sequential listing 116. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement a ledger, where data entries that have been posted to the immutable sequential listing cannot be altered. An immutable sequential listing may include a directed acyclic graph. As used in this disclosure, a “log” is a digital immutable ledger where data entries may be posted and cannot be altered. Log 120 may include a distributed ledger, wherein distributed ledger is stored on a network of nodes. Distributed ledger may be implemented using a decentralized structure wherein data is stored on a network of nodes. Transactions may be validated through the network of nodes, wherein each node may validate distributed ledger. Distributed ledger may allow for a decentralized and/or automated transaction. Distributed ledger may also allow for recordation of financial transactions. Distributed ledger may further allow for storage of encrypted data such that a digital identity of an individual is secured. Distributed ledger may further allow for a self-executing data structure to be executed as described in this disclosure. Log 120 may be distributed across some or all nodes 112a-n on network 108, such as a peer-to-peer network, whereby each node 112 replicates and saves an identical copy of log 120 and updates itself independently. A common example of an immutable sequential listing is a blockchain. System 100 may include embodiments of an immutable sequential listing discussed below in reference to FIG. 2. Immutable sequential listing 116 may include multiple immutable sequential listings. Immutable sequential listing 116 may include shared and synchronized digital data which may be spread across multiple sites. Immutable sequential listing 116 may be stored and/or implemented on two or more nodes 112a-n that may be connected by network 108, such as on a peer-to-peer network. Node 112 may include a device such as computing device 104, any remote device, or the like. Nodes 112a-n may be connected by network 108 and share information through log 120 that is distributed. There may be no central administrator or centralized data storage of information and/or data located on immutable sequential listing 116. As information is entered onto and updated on log 120 shared by nodes 112a-n on network 108, each node 112 may construct a new transaction. Nodes 112a-n may then vote by a consensus algorithm as to which copy is correct. Consensus algorithms may include proof of work, proof of stake, or voting systems. Once a consensus has been determined, all other nodes 112 may update themselves to reflect the new copy of log 120. In some embodiments, nodes 112a-n may copy log 120 in its entirety. In other embodiments, nodes 112a-n may copy one or more portions of log 120. Nodes 112a-n may be connected through a peer-to-peer networking whereby nodes 112a-n are equally privileged and equipotent participants. A peer-to-peer network may include a network of nodes 112a-n that may make a portion of their resources available to other network 108 participants. This may include resources such as processing power, disk storage or network bandwidth. Nodes 112a-n located on a peer-to-peer network may both supply and consume resources. System 100 may utilize cryptographic keys and digital signatures to ensure node security and/or authenticity. System 100 may utilize digitally signed assertions as described in more detail below in reference to FIG. 2.

Still referring to FIG. 1, system 100 may include a token 124. As used in this disclosure, a “token” is a unique and non-interchangeable unit of data stored on a ledger representing ownership of an asset and/or a financial interest. Accordingly, token 124 may prove ownership of the asset and/or financial interest. An asset may include physical artwork, digital artwork, music, in-game items, videos, photographs, real estate, and the like. As used in this disclosure, “financial interest” is anything of monetary value. In some cases, token 124 may include a nonfungible token (“NFT”). The monetary value of a financial interest may not be readily ascertainable or realized. For example, token may represent a financial interest in a portion of a selling price of a specified asset should the current owner of the specified asset ever sell the asset. Token 124 may include information of the asset of which it represents ownership, such as a unique fingerprint of the asset file, a token name, a token symbol, and/or a link to a file posted on an interplanetary file system (“IPFS”). Computing device 104 may be configured to generate token 124. Token 124 may be included in log 120 as part of immutable sequence listing and computing devices 104a-n in network 108 may copy at least a portion of token 124. In some embodiments, computing devices 104a-n copy token 124 in its entirety as part of log 120. Token 124 may include a plurality of tokens. Token 124 may be accessible at any of various security settings; for instance, and without limitation, token 124 may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Token 124 may exist in more than one level, including, without limitation, a first access level or community of permitted entities and/or devices having ability to read, and a second access level or community of permitted entities and/or devices having ability to write; first and second community may be overlapping or non-overlapping. Computing device 104 may be configured to record in immutable sequence listing 116 and/or log 120 various events such as a creation of token 124, an initial purchase of the token 124, and any resales of the token 124, any sales and/or resales of shares of tokens, tickets based on tokens, or the like, including without limitation the identity of the seller and purchaser, the purchase price, and/or a timestamp of the transaction. Computing device 104 may be configured to receive an indication of a first process associating a first token 124 with a first quantitative field; first process may alternatively or additionally convey a share of first token 124 and/or a ticket based on the first quantitative field. A “First process” for the purposes of this disclosure is the exchange or transfer of a token. In some cases, first process may include a transaction associated with a token. Quantitative “field” for the purposes of this disclosure is a numerical value associated with a particular component such as a token. For example, quantitative field may be a numerical value associated with the purchase price or the purchase price of token 124. In another non-limiting example, quantitative field may include the number of times a token has been transferred. In some cases, quantitative field may include a value associated with a transaction. First process may include a transfer of ownership of first token 124, share, and/or ticket. The indication may be from receiving an updated log 120 or portion of an updated log 120 that identifies first process. First token 124 may comprise, be linked to, and/or refer to a first verification datum of the purchaser, where a verification datum is data that may authenticate the location of first token 124. In some cases, verification datum is an address of a token or any address as discussed below in reference to FIG. 2. Computing device 104 may be configured to identify at least a second process in log 120, the at least a second process being associated with at least a second token 124, a share thereof, and/or a ticket based thereon, the at least a second token 124 linked to a second verification datum. In some cases, second process may include a second transaction associated with a token. Second verification datum may be one or more addresses of the one or more owners of at least a second token 124. Identification of at least a second token 124 and/or at least a second process may include identification of data associated with at least a second token 124 that matches data associated with first token, where such identification may include, without limitation, classification; alternatively or additionally, identification may include determination and/or proof that such matching data is accumulated in a cryptographic accumulator associated with at least a second token 124. Association of a cryptographic accumulator with a token may include without limitation incorporation of a root of cryptographic accumulator, and/or a representation or identifier thereof, in a token, association of such a root with or at a location, address, URL, or the like associated with the token, incorporation of a root, representation thereof, or identifier thereof in a digitally signed assertion or other cryptographic primitive with token and/or an identifier thereof, or the like.

Computing device 104 may be configured to identify a first proportion of the first quantitative field, the first proportion linked to the first verification datum. As described below, first proportion of first quantitative field may be the token value of first token 124, share, and/or ticket less a royalty. “Token Value” as described herein is the intrinsic worth of a token. Token value may include the purchase price of a token. In some cases first proportion of first quantitative field may include 90% of first quantitative field and/or value. Computing device 104 may be configured to calculate at least a second proportion of the first quantitative field, also referred to herein as “royalty”, to be transferred to the second verification datum. Computing device 104 may be configured to generate at least a third process linking the at least a second proportion of the first quantitative field to the second verification datum. Additionally or alternatively generating at least a third process may further include generating and executing a self-executing data structure 128, wherein self-executing data structure 128 may generate and process third process. In some cases, third process may include a third transaction associated with a token.

With continued reference to FIG. 1, computing device 104 may be configured to generate and execute self-executing data structure 128. As used in this disclosure, a “self-executing data structure” is an executable program including rules that can process inputs which may trigger one or more actions that a computing device automatically executes. Self-executing data structure may be consistent with a smart contract. Self-executing data structure may execute when a set of predetermined conditions are met. The predetermined conditions may include an indication of a transaction such as a transaction of a token as described in this disclosure. For example, self-executing data structure may execute when a first process is recorded. Self-executing data structure 128 may be used to automate a transaction and/or a process or a plurality of transactions and/or processes. In some cases, self-executing data structure 128 may be used to determine a plurality of processes, wherein each process may be distinct and separate from one another. For example, self-executing data structure may process a first and second process, wherein the first process may contain a different quantitative field and/or value than the second process. In some cases, self-executing data structure may process multiple processes simultaneously. In some cases, self-executing data structure 128 may contain a set of instructions that determine conditions for a plurality of processes. The set of instructions may process a predetermined amount for a first process and a predetermined amount for a second process. Self-executing data structure may contain information such as the identities of the parties involved, and financial information of the parties involved. Self-executing data structure 128 may be included in log 120 as part of immutable sequence listing such as a blockchain or a distributed ledger, wherein self-executing data structure may store and maintain records of transactions. Computing devices 104a-n in network 108 may copy at least a portion of self-executing data structure 128. In some embodiments, computing devices 104a-n copy self-executing data structure 128 in its entirety as part of log 120. Self-executing data structure 128 may include multiple self-executing data structures. Self-executing data structure 128 may include token 124, multiple shares of token 124, and/or multiple tickets based on token 124. tokens 124 may include multiple groups of tokens, shares of one or more tokens, and/or one or more tickets based on tokens and/or shares. For example, a first group of tokens 124 may represent ownership of financial interest, such as an interest in a portion of a token value for future sales of one or more tokens 124, shares thereof, and/or tickets based thereon, such as one or more tokens 124, or shares thereof or tickets based thereon, in the first group and/or other tokens 124 and/or shares thereof and/or tickets based thereon. In some embodiments, a fixed percentage of the token value for future sales of tokens 124, shares, thereof, and/or tickets based thereon, as referred to in this disclosure as a “royalty”, may be shared among the rest of the owners of tokens 124, owners of shares in tokens, and/or owners of tickets, excluding the seller and buyer of the sale. A second group of tokens 124 may represent ownership of asset. Second group of tokens 124 may also represent ownership of financial interest, such as an interest in a portion of a token value for future sales of one or more tokens 124 such as one or more tokens 124 in the first group and/or other tokens 124. tokens 124 may include a third group of tokens 124, a fourth group of tokens 124, a fifth group of tokens 124, a sixth group of tokens 124, and any number of groups of tokens 124. In some embodiments, tokens 124 within each group may have an equal interest or “share” in a portion of token value for future sales of tokens 124. In some embodiments, tokens 124 within a group may have unequal interests, such as unequal shares, in a portion of token value for future sales of tokens 124 and thus the owners may receive different percentages of the royalty. For example, if there are eleven distributed tokens 124 and an owner resells a particular token 124, share of an token, and/or ticket based on an token for $100, and the royalty to be shared among current owners of tokens 124 may be ten percent of the token value, and/or 10 percent of a fraction of the token value represented by the fractional value of the share and/or ticket sold; self-executing data structure 128 may distribute $10 among the other owners of tokens 124, shares, and/or tickets if the owners of tokens 124 have equal shares each in the amount of $1. Using the same example except that one of the ten owners of tokens 124 has two shares while the other nine existing owners each have one share, the former owner will receive a portion double that of the other owners in the amount of approximately $1.82. As self-executing data structure 128 may distribute a royalty of token 124 sales to be shared among current owners of tokens 124, there is a financial incentive to purchase token 124 early while there are fewer current owners with whom to share the royalty. For example, in some embodiments, all of a token value of a first token 124 initially sold goes to the seller as there are no other current token 124 owners at the time of the sale to collect a royalty. When a second token 124, and/or a share thereof and/or a ticket based thereon, is initially sold, self-executing data structure 128 may direct all of royalty to the owner of first token 124. An advantage to this, for example in embodiments wherein at least some of tokens 124 represent ownership of asset, owners of tokens 124 realize appreciating of the asset when resold. In some embodiments, the shares for owners of tokens 124 representing ownership of asset may be based on recent token values of one or more tokens 124 representing ownership of asset, on recent token values for shares of such tokens, and/or on recent token values for tickets based on such tokens. For example, shares of a royalty for a current owner of token 124 representing ownership of asset may be calculated as equal to the fraction of the latest token value of that token 124 out of the latest token values of all tokens 124 represent ownership of an asset. Thus, an owner of token 124, share, and/or ticket that represents ownership of an asset that has significantly increased in value compared to other assets of other corresponding tokens 124 shares and/or tickets, will receive a greater portion of the royalty for future token 124, share, and/or ticket sales.

In some embodiments, until all tokens in a series have been sold, a denominator in the division of that royalty slice, such as a 10% slice, among all existing holders may change from sale to sale. In particular, the very first sale may send its slice to zero holders, so that it goes instead to the seller, namely the creator of the token series; the second sale's slice may go entirely to a holder of the first token's ticket; a third sale's slice may be divided evenly between the first two ticket holders; and so on. This may incentivize early purchases of artifacts; it may represent an incentive not present in collections without coupling of financial rights. In contrast to “conventional” tokens, creators may choose not to reserve any percentage for themselves of any subsequent sales after their initial sales.

In some embodiments, the sale of a token 124 back to a creator may extinguish any financial interest among all exiting holders of token 124 or current owners of token 124. For example, when a creator of a token 124 purchases their token 124 back after an initial purchase, all existing holders may be extinguished and therefore the subsequent sale of token 124 may be treated as a first sale. As a result, the subsequent sale may send its slice to zero holders, so that it instead goes to the seller, namely the original creator of the token 124 series. In some cases, the creator may receive token 124 Through sale or assignment, wherein creator may burn token 124 and assign a new token 124 in order to extinguish all exiting holders of token 124. This may help a creator reassign rights and extinguish rights when needed. A token 124 may be burned by sending it to an address that cannot be accessed. The creator may then create a new token 124 with similar properties. As a result, all existing holders of the previous token 124 may be extinguished and a new token 124 takes the place of the original. In some cases, the current owner of an token 124 may reassign ownership of token 124 to the creator, wherein the creator may retire the token by bringing it and issuing a new token with the stated properties of the original token and also stating that the new token is the successor to the previous token 124. In some cases, creator may wrap or tokenize token 124 such that wrapped or tokenized version of the token 124. A “wrapping” or tokenizing process of an token 124 involves creating a new token 124 that represents the original token 124. The new token 124 represents and is tied to the same value of the original token 124. Creator may burn or hold onto the original token 124 and assign the wrapped token 124 such that all existing holders may not receive any financial benefit of subsequent sales of the wrapped token 124. This allows a creator to extinguish all rights of exiting holders if a creator is in possession of token 124. A wrapped token 124 may aid in creating new instructions or self-executing data structures with new terms that are associated with token 124. For example, a creator may seek to alter the terms of self-executing data structure 128 such that any future holders of token 124 may receive a different portion of sale proceeds when wrapped token 124 is sold. In some cases, creator of a token 124 may benefit from wrapping token 124 when the number of existing owners is too large such that any fractional value of subsequent sales are minimal. In some cases, a creator may seek to wrap token 124 such that existing holders receive a smaller share of or “royalty” of subsequent sales. This may be beneficial when buyers are discouraged to purchase token 124 out of fear that a profit may not be made in any future sales. In some cases, token 124 may be wrapped or tokenized such that subsequent holders may transfer token 124 on a platform not currently supported by token 124. In some cases, a creator may wrap or tokenize token 124 in order to take advantage of a newer or faster blockchain wherein faster transactions may increase the attractiveness of token 124.

In some embodiments, self-executing data structure 128 may include an upgradeable self-executing data structure. A creator may utilize an upgradeable contract in order to alter the financial rights of existing holders and the like. This will allow a creator to completely assign the financial rights of token 124 to a single individual or alter existing rights by increasing or decreasing the royalties given to existing holders and the like. An “Upgradeable self-executing data structure” is a self-executing data structure that allows for instructions to be altered or updated. Since a self-executing data structure cannot generally be altered, an upgradeable self-executing data structure may utilize proxies in order to update the terms of a contract associated with token 124. An upgradeable self-executing data structure can be created by changing the logic used to access self-executing data structure. Upgradeable self-executing data structure contains a proxy contract that is configured to call a self-executing data structure. A user may interact with proxy contract in order to call a different self-executing data structure having updated or altered terms. While a self-executing data structure may not be altered, a proxy contract may be used to call another self-executing data structure to be executed with differing terms. For example, a creator of token 124 may seek to alter the financial rights of existing holders, wherein the creator may cease any financial interests in subsequent sales of token 124. As a result, the creator may use proxy contract to call a differing self-executing data structure that executes terms that do not give financial rights to existing holders. This may be used in lieu of burning or reassigning token 124s as described above. A creator who rebuys their token 124 may choose to extinguish the rights of all existing holders by calling a different self-executing data structure using a proxy contract. Upgradeable self-executing data structure may further be used to identify any lingering issues in the original self-executing data structure. An upgradeable self-executing data structure may further be used to alter the terms of an existing self-executing data structure, such as for example, by voting with exiting holders on what terms may be changed or altered for a new self-executing data structure. Terms may be upgraded or altered such that subsequent sales may have differing terms.

Continuing to refer to FIG. 1, certain early sales may be of “golden” tickets, each worth one ticket, which don't have artifacts associated with them (as do conventional tokens), and thus are purely financial items. These may be associated with a marketing campaign by buyers in order to participate in a broader marketing campaign for an entire token series. These early sales may precede the public auction of the remaining tokens in the series.

Still referring to FIG. 1, self-executing data structure 128 may have access to funds of buyers and sellers of tokens 124. Funds may be cryptocurrency as discussed below and/or fiat currency and may be in one or more accounts. Self-executing data structure 128 may be configured to automatically transfer funds and tokens 124 from buyer to seller at the point of sale of tokens 124. Self-executing data structure 128 may be configured to automatically at the point of sale direct a royalty to current owners of tokens 124 as discussed above and dictated by the terms of self-executing data structure 128. In some embodiments, buyers and sellers provide access to currency accounts. In some embodiments, self-executing data structure 128 determines whether buyer has sufficient available funds before finalizing the sale. In some embodiments, self-executing data structure 128 may have access to a holding account similar to an escrow account and require buyer to transfer sufficient funds to the holding account prior to sale.

Still referring to FIG. 1, verification datum and/or related data such as without limitation media associated with token 124 may be accumulated by computing device 104 using a cryptographic accumulator. A cryptographic accumulator may accumulate verification datum of token 124, an address of token and/or a unique ID associated with a token. In some cases cryptographic accumulator may accumulate data associated with a plurality of tokens as described in this disclosure, such as but not limited to, first token, second token, third token and the like. Media, data, verification datum, and/or address may be input into a cryptographic accumulator wherein cryptographic accumulator may output a fixed root associated with Media, data, verification datum, and/or address. Cryptographic accumulator, membership proofs of data accumulated, or the like, including without limitation any secure proofs as described herein, may be used to verify that a user is the owner of a particular token 124 without revealing the verification datum and/or address of Token 124; alternatively or additionally, such proofs may be used to establish an association of an element of data with a token, including without limitation showing that an element of data, such as an image, textual datum, or the like, associated with one token is associated with another token. In some cases, A token ID of token 124 may be input into a cryptographic accumulator wherein output of cryptographic accumulator may be used to verify ownership of token 124 without revealing Token ID. In some cases, cryptographic accumulator may be used to preserve the privacy of a particular token owner. In some cases, cryptographic accumulator may be configured to provide zero knowledge proof of membership wherein owners of a token or those with financial interest may prove ownership or financial interest in a token without revealing the identity of the owners or those with financial interest. Zero knowledge proof may be constructed using a cryptographic accumulator wherein a set of Token IDs are input into cryptographic accumulator and an output of cryptographic accumulator may be used to verify ownership of token without the Token ID. Zero knowledge proof may be beneficial in situations in which a user may seek to prove ownership of a Token without revealing the Token ID.

With continued reference to FIG. 1, verification of token with a quantitative field or linking a token to token verification datum and/or element of other data may include using a classifier, such as an image classifier, Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. A classifier may be used to classify token data associated with one token, such as at least a second token, to token data associated with another token, such as first token, or vice versa. NFT data may be classified such that a particular NFT may belong to a particular owner. Such association in turn may be used to establish ownership, associations, or the like of or between tokens.

Referring now to FIG. 2, an exemplary embodiment of an immutable sequential listing 200 is illustrated. Data elements are listed in immutable sequential listing 200; data elements may include any form of data, including textual data, image data, encrypted data, cryptographically hashed data, and the like. Data elements may include, without limitation, hash values such as hashes of previous sub-listings and/or of transactions in the current block, plaintext values, digitally signed assertions, and/or any other element of data. In one embodiment, a digitally signed assertion 204 may include a collection of textual data signed using a secure proof as described in this disclosure; secure proof may include, without limitation, a digital signature. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or ciphertext data; in an embodiment, collection of textual data may be encrypted, or may be a hash of other data, such as a root or node of a Merkle tree or hash tree, or a hash of any other information desired to be recorded in some fashion using a an individual transaction and/or record 204 which may include without limitation a digitally signed assertion. In an embodiment, collection of textual data states that the owner of a certain transferable item represented in a digitally signed assertion 204 register is transferring that item to the owner of an address as described in further detail below. A digitally signed assertion 204 may be signed by a digital signature created using the private key associated with the owner's public key, as described above.

Still referring to FIG. 2, an individual transaction and/or record 204 may describe a transfer of virtual currency, such as crypto currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. An individual transaction and/or record 204 may describe the transfer of a physical good; for instance, an individual transaction and/or record 204 may describe the sale of token. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with an individual transaction and/or record 204 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 2, as used in this disclosure, an “address” is a textual datum identifying the recipient of virtual currency or another item of value such as token in an individual transaction and/or record 204, and/or functioning as an identifier of a person or entity. In some embodiments, address may be linked to a public key, the corresponding private key of which is owned by the recipient of an individual transaction and/or record 204 such as a digitally signed assertion. For instance, address may be the public key. Address may be a representation, such as a hash, of the public key. Address may be linked to the public key in memory of a computing device, for instance via a “wallet shortener” protocol. Where address is linked to a public key, a transferee in an individual transaction and/or record 204 such as a digitally signed assertion may record a subsequent transaction, record, and/or digitally signed assertion 204 transferring some or all of the value transferred in the first process, record, and/or digitally signed assertion 204 to a new address in the same manner. A transaction, record, and/or digitally signed assertion 204 may contain textual information that is not a transfer of some item of value in addition to, or as an alternative to, such a transfer. For instance, as described in further detail below, a transaction, record, and/or digitally signed assertion 204 may indicate a confidence level associated with a distributed storage node as described in further detail below.

In an embodiment, and still referring to FIG. 2 immutable sequential listing 200 records a series of at least a posted content in a way that preserves the order in which the at least a posted content took place. Temporally sequential listing may be accessible at any of various security settings; for instance, and without limitation, temporally sequential listing may be readable and appendable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 200 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 2, immutable sequential listing 200 may preserve the order in which the at least a posted content took place by listing them in chronological order; alternatively or additionally, immutable sequential listing 200 may organize digitally signed assertions 204 into sub-listings 208 such as “blocks” in a blockchain, which may be themselves collected in a temporally sequential order; digitally signed assertions 204 within a sub-listing 208 may or may not be temporally sequential. The ledger may preserve the order in which at least a posted content took place by listing them in sub-listings 208 and placing the sub-listings 208 in chronological order. The immutable sequential listing 200 may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature, and/or by inclusion of a hash of each block in each subsequent block as described in this disclosure. Immutable sequential listing 200 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, in the ANSI ASC x9.95 standard, and/or in the ISO/IEC 18014 standard. In another embodiment, the trusted time ordering is provided by a group of entities collectively acting as the time stamping authority with a requirement that a threshold number of the group of authorities sign the timestamp.

In some embodiments, and with continued reference to FIG. 2, immutable sequential listing 200, once formed, may be inalterable by any party, no matter what access rights that party possesses. For instance, immutable sequential listing 200 may include a hash chain, in which data is added during a successive hashing process to ensure non-repudiation and/or immutability. Immutable sequential listing 200 may include a block chain. In one embodiment, a block chain is immutable sequential listing 200 that records one or more new at least a posted content in a data item known as a sub-listing 208 or “block.” An example of a block chain is the BITCOIN block chain used to record BITCOIN transactions and values. Sub-listings 208 may be created in a way that places the sub-listings 208 in chronological order and link each sub-listing 208 to a previous sub-listing 208 in the chronological order so that any computing device may traverse the sub-listings 208 in reverse chronological order to verify any at least a posted content listed in the block chain. Each new sub-listing 208 may be required to contain a cryptographic hash describing the previous sub-listing 208. In some embodiments, the block chain may contain a single first sub-listing 208 sometimes known as a “genesis block.”

Still referring to FIG. 2, the creation of a new sub-listing 208 may be computationally expensive; for instance, the creation of a new sub-listing 208 may be designed by a “proof of work” protocol accepted by all participants in forming the immutable sequential listing 200 to take a powerful set of computing devices a certain period of time to produce. Where one sub-listing 208 takes less time for a given set of computing devices to produce the sub-listing 208, protocol may adjust the algorithm to produce the next sub-listing 208 so that it will require more steps; where one sub-listing 208 takes more time for a given set of computing devices to produce the sub-listing 208, protocol may adjust the algorithm to produce the next sub-listing 208 so that it will require fewer steps. As an example, protocol may require a new sub-listing 208 to contain a cryptographic hash describing its contents; the cryptographic hash may be required to satisfy a mathematical condition, achieved by having the sub-listing 208 contain a number, called a nonce, whose value is determined after the fact by the discovery of the hash that satisfies the mathematical condition. Continuing the example, the protocol may be able to adjust the mathematical condition so that the discovery of the hash describing a sub-listing 208 and satisfying the mathematical condition requires more or fewer steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 208 according to the protocol is known as “mining.” The creation of a new sub-listing 208 may be designed by a “proof of stake” protocol as will be apparent to those skilled in the art upon reviewing the entirety of this disclosure.

Continuing to refer to FIG. 2, in some embodiments, protocol also creates an incentive to mine new sub-listings 208. The incentive may be financial; for instance, successfully mining a new sub-listing 208 may result in the person or entity that mines the sub-listing 208 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 208. Each sub-listing 208 created in immutable sequential listing 200 may contain a record or at least a posted content describing one or more addresses that receive an incentive, such as virtual currency, as the result of successfully mining the sub-listing 208.

With continued reference to FIG. 2, where two entities simultaneously create new sub-listings 208, immutable sequential listing 200 may develop a fork; protocol may determine which of the two alternate branches in the fork is the valid new portion of the immutable sequential listing 200 by evaluating, after a certain amount of time has passed, which branch is longer. “Length” may be measured according to the number of sub-listings 208 in the branch. Length may be measured according to the total computational cost of producing the branch. Protocol may treat only at least a posted content contained in the valid branch as valid at least a posted content. When a branch is found invalid according to this protocol, at least a posted content registered in that branch may be recreated in a new sub-listing 208 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 200 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 200.

Still referring to FIG. 2, additional data linked to at least a posted content may be incorporated in sub-listings 208 in the immutable sequential listing 200; for instance, data may be incorporated in one or more fields recognized by block chain protocols that permit a person or computer forming a at least a posted content to insert additional data in the immutable sequential listing 200. In some embodiments, additional data is incorporated in an unspendable at least a posted content field. For instance, the data may be incorporated in an OP RETURN within the BITCOIN block chain. In other embodiments, additional data is incorporated in one signature of a multi-signature at least a posted content. In an embodiment, a multi-signature at least a posted content is at least a posted content from at least one of two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. The latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 2, in some embodiments, virtual currency is traded as a crypto currency. In one embodiment, a crypto currency is a digital, currency such as Bitcoins, Etherium, Peercoins, Namecoins, and Litecoins. Crypto-currency may be a clone of another crypto-currency. The crypto-currency may be an “alt-coin.” Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto currency may be centralized, with its protocols enforced or hosted by a particular entity. For instance, crypto currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 208 in a block chain computationally challenging; the incentive for producing sub-listings 208 may include the grant of new crypto currency to the miners. Quantities of crypto currency may be exchanged using at least a posted content as described above.

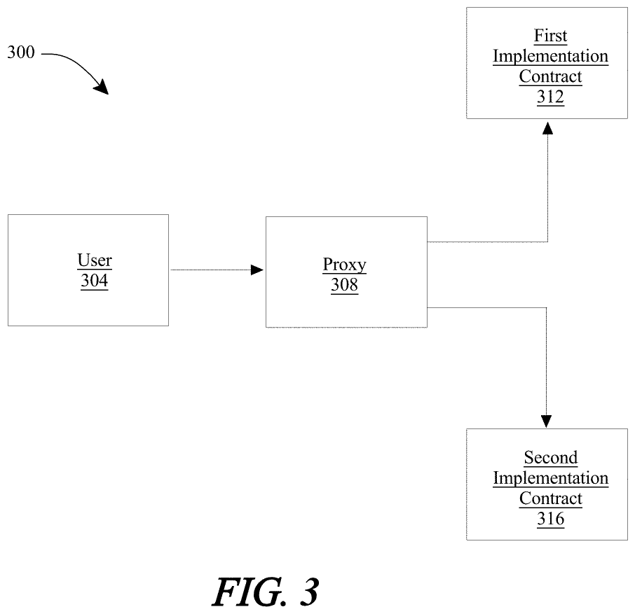

Referring now to FIG. 3, an exemplary embodiment of an upgradeable smart contract 300 is illustrated. In some cases, upgradeable smart contract 300 may be consistent with an upgradable self-executing data structure. “Upgradeable smart contract” for the purposes of this disclosure is a smart contract that can be modified or upgraded. As opposed to a smart contract that is immutable, an upgradeable smart contract may allow for the upgrade or modification of a smart contract through the use of proxies, data separation and/or contract mitigation. In contract migration, data from the original smart contract is recovered and written to a new smart contract. Contract migration may be useful in instances where an existing smart contract has been comprised and a new smart contract must be implemented. In data separation, business logic and management logic are separated into different contracts. The “business logic” governs the execution of the contract and the particular contract to be executed while the “management logic” governs the terms of the contract. In data separation, the management logic of the contract may be located on an immutable sequential listing such as one described in this disclosure whereas the business logic may be stored on a server. The business logic of the contract may be altered or upgraded such that users may alter the terms of when the smart contract may be executed. For example, a user may alter the business logic of a smart contract such that the smart contract only executes after a delivery of an item rather than the payment of the item. In data separation the terms of the contract are immutable while the terms of execution may be altered and changed.

With continued reference to FIG. 3, upgradeable smart contract 300 may further include a proxy contract such as the proxy contract illustrated in FIG. 3. Upgradable smart contract may include a user 304 that interacts with the upgradable smart contract wherein user may alter the terms of upgradable smart contract. User may include any user that may have access to upgradable smart contract 300. Upgradable smart contract may include a proxy 308 wherein a user may change the address of proxy 308 to point to a different smart contract. For the purposes of this disclosure a “proxy” is an intermediary contract that may be used to call a smart contract. While a proxy contract may be immutable due to its storage on an immutable sequential listing such as a blockchain, the address of the proxy contract may be changed such that it points to a new smart contract. In instances wherein a smart contract may need to be upgraded or modified, a user may utilize proxy 308 in order to call another smart contract. Because a smart contract cannot be modified, an upgradeable smart contract may “modify” a smart contract by using proxy 308 in order to call another smart contract. In this instance a user may use proxy to call first implementation contract 312 wherein first implementation contract is a smart contract containing predefined terms. When a user wishes to alter the terms of the contract, user 304 may utilize proxy 308 to call second implementation contract 316 wherein second implementation contract 316 may contain differing terms than first implementation contract 312. Second implementation contract 316 may be created after first implementation contract 312. A user may seek to use a proxy when the terms of a first contract such as first implementation contract are no longer preferable.

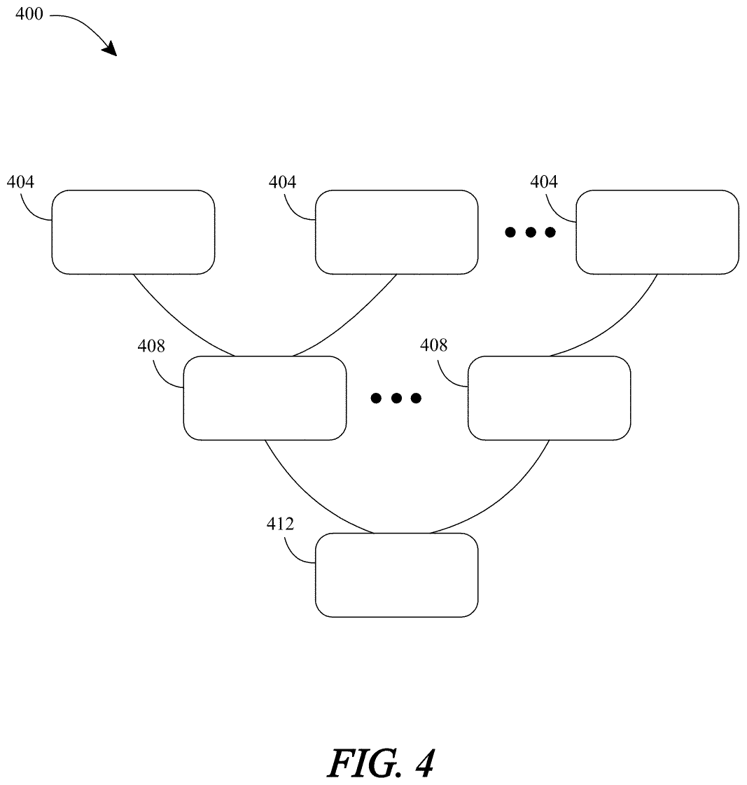

Referring now to FIG. 4, an exemplary embodiment of a cryptographic accumulator 400 is illustrated. A “cryptographic accumulator,” as used in this disclosure, is a data structure created by relating a commitment, which may be smaller amount of data that may be referred to as an “accumulator” and/or “root,” to a set of elements, such as lots of data and/or collection of data, together with short membership and/or nonmembership proofs for any element in the set. In an embodiment, these proofs may be publicly verifiable against the commitment. An accumulator may be said to be “dynamic” if the commitment and membership proofs can be updated efficiently as elements are added or removed from the set, at unit cost independent of the number of accumulated elements; an accumulator for which this is not the case may be referred to as “static.” A membership proof may be referred to as a as a “witness” whereby an element existing in the larger amount of data can be shown to be included in the root, while an element not existing in the larger amount of data can be shown not to be included in the root, where “inclusion” indicates that the included element was a part of the process of generating the root, and therefore was included in the original larger data set. Cryptographic accumulator 400 has a plurality of accumulated elements 404, each accumulated element 404 generated from a lot of the plurality of data lots. Accumulated elements 404 are create using an encryption process, defined for this purpose as a process that renders the lots of data unintelligible from the accumulated elements 404; this may be a one-way process such as a cryptographic hashing process and/or a reversible process such as encryption. Cryptographic accumulator 400 further includes structures and/or processes for conversion of accumulated elements 404 to root 412 element. For instance, and as illustrated for exemplary purposes in FIG. 4, cryptographic accumulator 400 may be implemented as a Merkle tree and/or hash tree, in which each accumulated element 404 created by cryptographically hashing a lot of data. Two or more accumulated elements 404 may be hashed together in a further cryptographic hashing process to produce a node 408 element; a plurality of node 408 elements may be hashed together to form parent nodes 408, and ultimately a set of nodes 408 may be combined and cryptographically hashed to form root 412. Contents of root 412 may thus be determined by contents of nodes 408 used to generate root 412, and consequently by contents of accumulated elements 404, which are determined by contents of lots used to generate accumulated elements 404. As a result of collision resistance and avalanche effects of hashing algorithms, any change in any lot, accumulated element 404, and/or node 408 is virtually certain to cause a change in root 412; thus, it may be computationally infeasible to modify any element of Merkle and/or hash tree without the modification being detectable as generating a different root 412. In an embodiment, any accumulated element 404 and/or all intervening nodes 408 between accumulated element 404 and root 412 may be made available without revealing anything about a lot of data used to generate accumulated element 404; lot of data may be kept secret and/or demonstrated with a secure proof as described below, preventing any unauthorized party from acquiring data in lot.

Alternatively or additionally, and still referring to FIG. 4, cryptographic accumulator 400 may include a “vector commitment” which may act as an accumulator in which an order of elements in set is preserved in its root 412 and/or commitment. In an embodiment, a vector commitment may be a position binding commitment and can be opened at any position to a unique value with a short proof (sublinear in the length of the vector). A Merkle tree may be seen as a vector commitment with logarithmic size openings. Subvector commitments may include vector commitments where a subset of the vector positions can be opened in a single short proof (sublinear in the size of the subset). Persons skilled in the art, upon reviewing the entirety of this disclosure, will be aware of various alternative or additional cryptographic accumulators 400 that may be used as described herein. In addition to Merkle trees, accumulators may include without limitation RSA accumulators, class group accumulators, and/or bi-linear pairing-based accumulators. Any accumulator may operate using one-way functions that are easy to verify but infeasible to reverse, i.e. given an input it is easy to produce an output of the one-way function but given an output it is computationally infeasible and/or impossible to generate the input that produces the output via the one-way function. For instance, and by way of illustration, a Merkle tree may be based on a hash function as described above. Data elements may be hashed and grouped together. Then, the hashes of those groups may be hashed again and grouped together with the hashes of other groups this hashing and grouping may continue until only a single hash remains. As a further non-limiting example, RSA and class group accumulators may be based on the fact that it is infeasible to compute an arbitrary root of an element in a cyclic group of unknown order, whereas arbitrary powers of elements are easy to compute. A data element may be added to the accumulator by hashing the data element successively until the hash is a prime number and then taking the accumulator to the power of that prime number. The witness may be the accumulator prior to exponentiation. Bi-linear paring-based accumulators may be based on the infeasibility found in elliptic curve cryptography, namely that finding a number k such that adding P to itself k times results in Q is impractical, whereas confirming that, given 4 points P, Q, R, S, the point, P needs to be added as many times to itself to result in Q as R needs to be added as many times to itself to result in S, can be computed efficiently for certain elliptic curves.

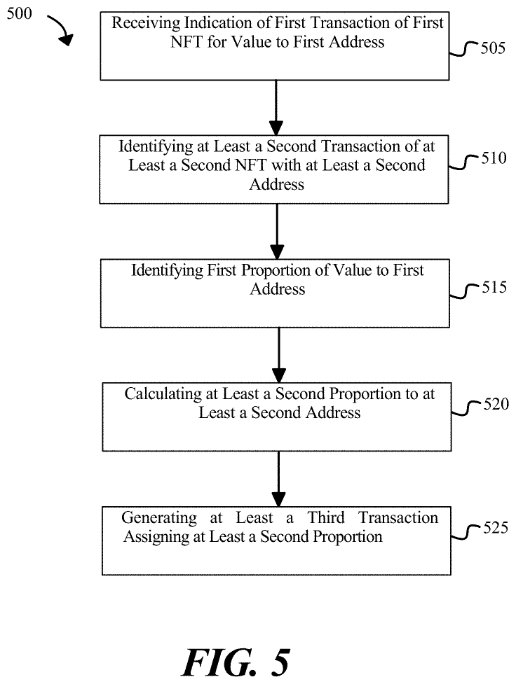

Now referring to FIG. 5, an exemplary method according to the present disclosure is illustrated. At step 505, a computing device receives an indication of a first process associating a first token with a first quantitative field, first token comprising a first address; this may be implemented, without limitation, as described above in reference to FIGS. 1-5. Self-executing data structure may establish the number of shares for each of tokens. Shares may be based on the number of tokens.

Still referring to FIG. 5, at step 510, computing device identifies at least a second process in a log, at least a second process being associated with at least a second token, at least a second token comprising at least a second address; this may be implemented, without limitation, as described above in reference to FIGS. 1-5. Each token of at least a second token may comprise at least a share. An amount of at least a second proportion assigned to each address of at least a second address may be based on the number of shares of the each token out of the number of shares of at least a second token. At least a first group of tokens of at least a second token may each comprise an equal number of shares. A private key may be required to create ledger. Computing device may be configured to copy at least a portion of log.

Still referring to FIG. 5, at step 515, computing device identifies a first proportion of the first quantitative field to be transferred to the first address. In some cases, first proportion of the first quantitative field may include 90% of the first quantitative field. This may be implemented, without limitation, as described above in reference to FIGS. 1-5.

At step 520, computing device calculates at least a second proportion of the first quantitative field to be transferred to the at least a second address; this may be implemented, without limitation, as described above in reference to FIGS. 1-5. Calculation may include determining a number of previous processes associated with the at least a second token; and calculating as a function of number. At least a second proportion may be based on first quantitative field.

At step 525, computing device generates at least a third process assigning the at least a second proportion of the first quantitative field; this may be implemented, without limitation, as described above in reference to FIGS. 1-5. In some cases generating the at least a third process assigning the at least a second proportion of the first quantitative field to the at least a second address further includes executing a self-executing data structure. Distribution may be based on shares of tokens. Self-executing data structure may revise shares based on the latest token values of tokens and/or the assets of which they represent ownership. An amount of the at least a second proportion assigned to each address of the at least a second address may be based on the number of tokens of at least a second token. At least a third process may assign an equal amount of at least a second proportion to each address of at least a second address. The amount of at least a second proportion assigned to each address of at least a second address may be based on a token value for each token.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

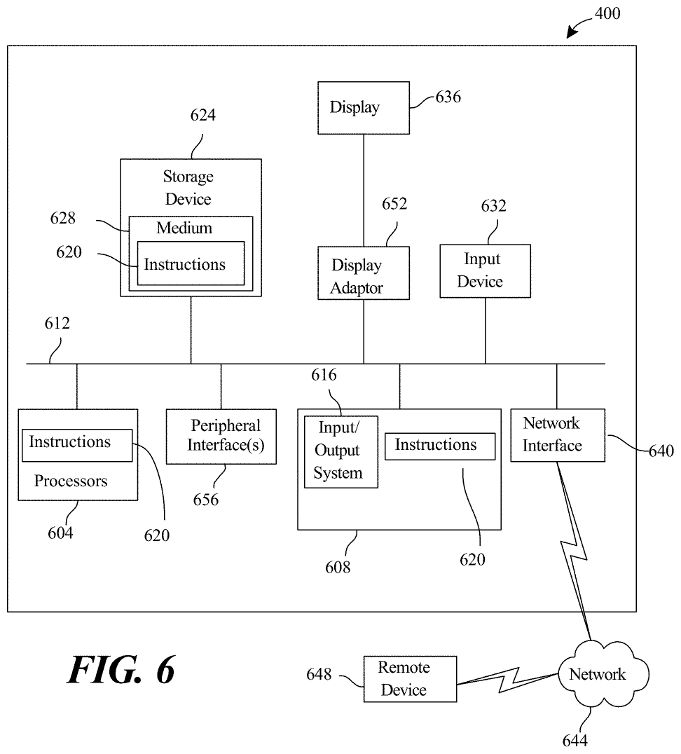

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1396 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for managing tokens, comprising:
a computing device configured to:
receive an indication of a first process associating a first token with a first quantitative field, the first token linked to a first verification datum;
identify at least a second process in a log, the at least a second process being associated with at least a second token, the at least a second token linked to a second verification datum;
identify a first proportion of the quantitative field, the first proportion linked to the first verification datum;
calculate at least a second proportion of the quantitative field; and
generate at least a third process linking the at least a second proportion to the second verification datum.

2. The system of claim 1, wherein calculating the at least a second proportion comprises:
determining a number of previous processes associated with the at least a second token; and
calculating the at least a second proportion as a function of the number.

3. The system of claim 1, wherein an amount of the at least a second proportion assigned to each verification datum of the at least a second verification datum is based on a number of tokens of the at least a second token.

4. The system of claim 1, wherein the at least a third process assigns an equal amount of the at least a second proportion to each verification datum of the at least a second verification datum.

5. The system of claim 1, wherein each token of the at least a second token comprises at least a share.

6. The system of claim 5, wherein at least a first group of tokens of the at least a second token each comprise an equal number of shares.

7. The system of claim 1, wherein the amount of the at least a second proportion assigned to each verification datum of the at least a second verification datum is based on a token value for a corresponding token of the at least a second token.

8. The system of claim 1, wherein the at least a second proportion is based on the first quantitative field.

9. The system of claim 1, wherein identifying the first proportion of the first quantitative field comprises identifying approximately 90% of the first quantitative field.

10. The system of claim 1, wherein generating the at least a third process assigning the at least a second proportion of the first quantitative field to the at least a second verification datum further comprises generating a self-executing data structure.

11. A method for managing tokens, comprising:
receiving, at a computing device, an indication of a first process associating a first token with a first quantitative field, the first token comprising a first verification datum;
identifying, by the computing device, at least a second process in a log, the at least a second process being associated with at least a second token, the at least a second token comprising at least a second verification datum;
identifying, by the computing device, a first proportion of the first quantitative field to be transferred to the first verification datum;
calculating, by the computing device, at least a second proportion of the first quantitative field to be transferred to the at least a second verification datum; and
generating, by the computing device, at least a third process assigning the at least a second proportion of the first quantitative field.

12. The method of claim 11, wherein the calculation comprises:
determining a number of previous processes associated with the at least a second token; and
calculating the at least a second proportion as a function of the number.

13. The method of claim 11, wherein an amount of the at least a second proportion assigned to each verification datum of the at least a second verification datum is based on the number of tokens of the at least a second token.

14. The method of claim 11, wherein the at least a third process assigns an equal amount of the at least a second proportion to each verification datum of the at least a second verification datum.

15. The method of claim 11, wherein each token of the at least a second token comprises at least a share.

16. The method of claim 15, wherein at least a first group of tokens of the at least a second token each comprise an equal number of shares.

17. The method of claim 11, wherein the amount of the at least a second proportion assigned to each verification datum of the at least a second verification datum is based on a token value for each token.

18. The method of claim 11, wherein the at least a second proportion is based on the first quantitative field.

19. The method of claim 11, wherein identifying the first proportion of the value comprises identifying approximately 90% of the first quantitative field.

20. The method of claim 11, wherein generating the at least a third process assigning the at least a second proportion of the first quantitative field to the at least a second verification datum further comprises generating a self-executing data structure.
